(19) United States
(12) Patent Application Publication
(10) Pub. No.: US 2025/0060275 A1
(43) Pub. Date: Feb. 20, 2025

(54) DEVICE AND METHOD FOR SHOCK FATIGUE TESTING FOR A POWERTRAIN MOUNT

(71) Applicants: HYUNDAI MOTOR COMPANY, Seoul (KR); KIA CORPORATION, Seoul (KR)

(72) Inventors: Woon Ki Cho, Seoul (KR); Jung Ho Park, Incheon (KR); Jong Hwan Jang, Gwangmyeong-si (KR); Ji Hyeon Lee, Suwon-si (KR); Hee Sung Lee, Suwon-si (KR); Moon Joon Kim, Suwon-si (KR); Soon Ju Kim, Cheonan-si (KR); Jin Young Lee, Seongnam-si (KR)

(73) Assignees: HYUNDAI MOTOR COMPANY, Seoul (KR); KIA CORPORATION, Seoul (KR)

(21) Appl. No.: 18/410,141

(22) Filed: Jan. 11, 2024

(30) Foreign Application Priority Data
Aug. 17, 2023 (KR) 10-2023-0107734

(51) Int. Cl. G01M 7/08

(52) U.S. Cl. CPC G01M 7/08

(57) ABSTRACT

A shock fatigue testing device for a powertrain mount includes: a main frame having a guide support vertically extending from a base plate and a mounting plate coupled to the guide support; a first mount jig mounted to the mounting plate and configured to support the upper portion of a mount member; a second mount jig mounted to a lower portion of the mount member and configured to support the lower portion of the mount member; a weight portion fixed to the second mount jig and configured to apply a load to the mount member; and a vibration portion configured to continuously provide vibration to the base plate to vibrate the weight portion using the main frame, the first mount jig, and the second mount jig as media.

### CROSS-REFERENCE TO RELATED APPLICATION

This application claims, under 35 U.S.C. § 119 (a), the benefit of and priority to Korean Patent Application No. 10-2023-0107734, filed on Aug. 17, 2023, the entire contents of which are incorporated herein by reference.

### BACKGROUND

### (a) Technical Field

The present disclosure relates to a device and a method for shock fatigue testing for a powertrain mount. More particularly, the present disclosure relates to a device and a method for shock fatigue testing for a powertrain mount to evaluate a shock resistance performance in a rough road travel condition.

### (b) Background Art

Generally, the powertrain of a vehicle not only vibrates for structural reasons, but may also vibrate due to the unevenness of a road surface on which the vehicle travels.

Particularly, when the vehicle accelerates with a high engine load on a severely uneven road surface or over a speed bump, a heavy shock load exceeding a maximum load, which may be generated by the powertrain, may occur due to an increase in the angular acceleration of the drivetrain and an increase in the tire contact area. The heavy load generated for a short period of time may affect the powertrain and the mount system as a shock load.

Currently, the strength and safety of the mount in relation to the shock load generated in a rough road travel condition has been evaluated and verified mostly on an actual vehicle due to difficulty in reproducing such a shock load. However, in an actual vehicle test, other components of the vehicle may be damaged by being exposed to a heavy shock load, rendering it difficult to evaluate the lifespan of the target mount, difficult to precisely verify the component safety factor, or difficult to implement an optimal design therefor.

When such conditions of repetitive heavy shock loads can be reproduced in a target testing device, the shortcomings in the actual vehicle test may be overcome. However, no testing device that reproduces such test conditions has been known to date.

The above information disclosed in this Background section is only to enhance understanding of the background of the present disclosure. Therefore, the Background section may contain information that does not form the prior art that is already known to a person of ordinary skill in the art.

### SUMMARY

The present disclosure has been made in an effort to solve the above-described problems associated with the prior art. It is an object of the present disclosure to provide a device and a method for shock fatigue testing for a powertrain mount allowing a shock resistance test to evaluate the shock resistance performance in a rough road travel condition. The shock resistance test to evaluate the shock resistance performance in a rough road travel condition, which traditionally could only be conducted on an actual vehicle, may be conducted in the shock fatigue testing device. This is achieved by reproducing actual vehicle test conditions in the testing device by the method performed such that a plurality of conditions for shock load occurrences is inputted to the shock fatigue testing device together with the mass and characteristic value of a weight portion and a mount mounted to the shock fatigue testing device to excite the shock fatigue testing device. The shock load on the mount is compared with a set shock load on a target to change the amplitude of the shock fatigue testing device. Therefore, when the shock load on the mount coincides with the shock load on the target, a shock fatigue test is conducted in a condition in which the mount vibrates with the corresponding amplitude.

In one embodiment, the present disclosure provides a shock fatigue testing device for a powertrain mount. The device includes a main frame having a guide support vertically extending from a base plate and a mounting plate coupled to the guide support. The device includes a first mount jig mounted to the mounting plate and configured to support the upper portion of a mount member, and a second mount jig mounted to a lower portion of the mount member and configured to support the lower portion of the mount member. The device also includes a weight portion fixed to the second mount jig and configured to apply a load to the mount member, and a vibration portion configured to continuously provide vibration to the base plate to vibrate the weight portion using the main frame, the first mount jig, and the second mount jig as media.

In an embodiment, the shock fatigue testing device may further include a controller configured to make a comparison between the load applied to the mount member and an inputted target load to selectively increase or decrease the amplitude of the vibration portion.

In another embodiment, the target load may be inputted by being set to the maximum shock load on an actual vehicle.

In still another embodiment, the controller may calculate the natural frequency of the mount member using a weight measurement for the weight portion and a characteristic value of the mount member to control the vibration portion to vibrate at a frequency identical to the calculated natural frequency of the mount member and with an inputted amplitude.

In yet another embodiment, the controller may be further configured to receive the load applied to the mount member from a load cell attached to the first mount jig in real time and to compare the same with the inputted target load.

In still yet another embodiment, the shock fatigue testing device may further include a displacement measurer mounted to the guide support and configured to evaluate the displacement of the weight portion in a vertical movement. The controller may be further configured to calculate and output a velocity and an acceleration of the weight portion using a displacement measurement for the weight portion received from the displacement measurer.

In a further embodiment, the weight portion may have a structure in which a plurality of unit weights is stacked and may be selectively varied in weight by assembling or disassembling the unit weights.

In another further embodiment, the weight portion may be coupled to a plurality of guide shafts disposed upright from the base plate by allowing the plurality of guide shafts to pass through the four corners of the weight portion, respectively, and may move up and down along the guide shafts by vibration.

In another embodiment, the present disclosure provides a method for shock fatigue testing for a powertrain mount. The method includes a first step of inputting a target load of a mount member to a controller, and a second step of calculating, by the controller, the natural frequency of the mount member using the weight measurement for a weight portion and the characteristic value of the mount member to control the vibration portion to vibrate at a frequency identical to the calculated natural frequency of the mount member and with an inputted amplitude. The method may further include a third step of receiving, by the controller, the load applied to the mount member in real time to compare the same with the target load, and a fourth step of, when the load applied to the mount member coincides with the target load, controlling the vibration portion to vibrate with a corresponding amplitude.

In an embodiment, the fourth step may include, when the load applied to the mount member does not coincide with the target load, selectively increasing or decreasing, by the controller, the amplitude of the vibration portion.

In another embodiment, the third step may include measuring the displacement of the weight portion in a vertical movement to calculate and output, by the controller, a velocity and an acceleration of the weight portion using the displacement measurement.

Other aspects and embodiments of the present disclosure are discussed below.

It is to be understood that the terms “vehicle” or “vehicular” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limited to the present disclosure, and wherein:

FIG. 1 is a view illustrating a shock fatigue testing device for a powertrain mount according to an embodiment of the present disclosure;

FIG. 2 is a view showing a structure of a shock fatigue testing device for a powertrain mount according to an embodiment of the present disclosure;

FIG. 3 is a flowchart of a method for shock fatigue testing for a powertrain mount according to an embodiment of the present disclosure;

FIG. 4 shows a comparison between a shock load on an actual vehicle and a shock load reproduced in a target in a method for shock fatigue testing for a powertrain mount according to an embodiment of the present disclosure; and

FIG. 5 shows a comparison between the load values and the number of load occurrences in 1 cycle for an actual vehicle and the same in 0.5 cycle for a target in a method for shock fatigue testing for a powertrain mount according to an embodiment of the present disclosure.

It should be understood that the appended drawings are not necessarily drawn to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Description is now given in detail according to embodiments disclosed herein, with reference to the accompanying drawings.

Advantages and features of the present disclosure, and a method of achieving the same, should be apparent with reference to the embodiments described below in detail and in conjunction with the accompanying drawings.

However, the present disclosure may be embodied in many different forms, and should not be construed as being limited to the embodiments set forth herein. Rather, the embodiments are provided so that the present disclosure is thorough and complete, and to fully convey the scope of the present disclosure to those having ordinary skill in the art. The present disclosure is defined only by the categories of the claims.

When a component, device, element, or the like of the present disclosure is described as having a purpose or performing an operation, function, or the like, the component, device, or element should be considered herein as being “configured to” meet that purpose or to perform that operation or function.

In describing the present disclosure, if a detailed explanation of a related known function or construction is considered to unnecessarily obscure the gist of the present disclosure, such explanation has been omitted because it would be understood by those having ordinary skill in the art.

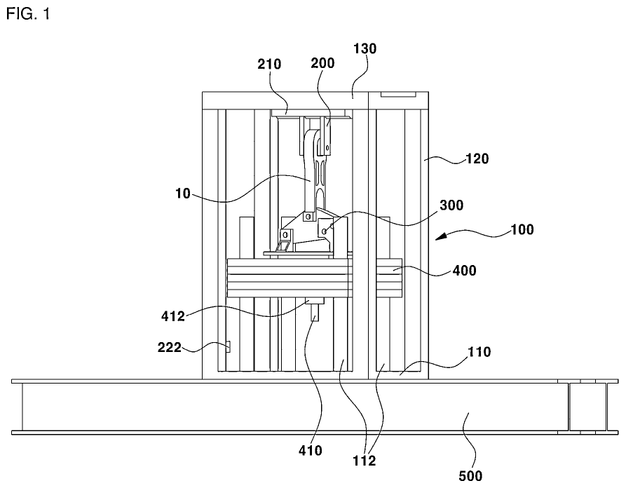

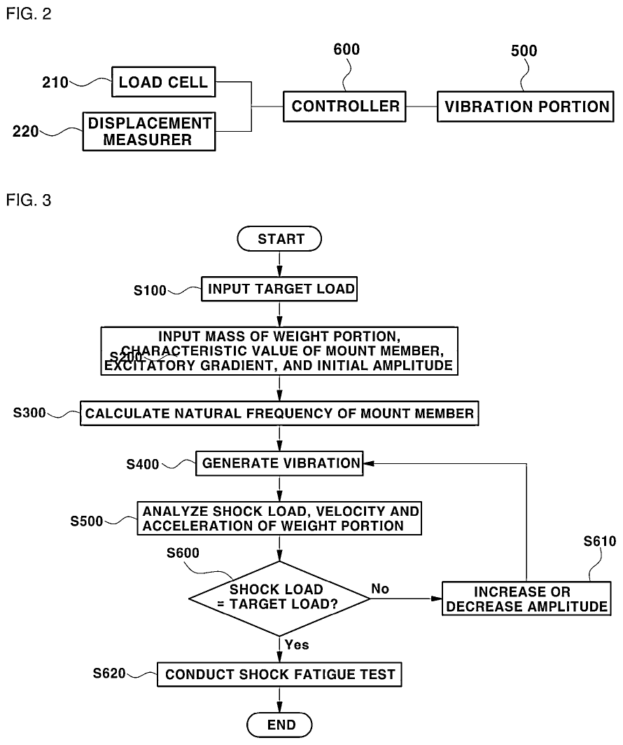

FIG. 1 is a view illustrating a shock fatigue testing device for a powertrain mount according to an embodiment of the present disclosure. FIG. 2 is a view showing a structure of a shock fatigue testing device for a powertrain mount according to an embodiment of the present disclosure.

Generally, when a vehicle travels harshly on a rough road including, for example, a continuously uneven area, a shock load is introduced into the wheels of the vehicle and is transmitted to a powertrain via a drive shaft. The shock load transmitted to the powertrain is supported by a mount.

A shock load exceeding wheel slip torque generated while traveling on the rough road is caused by the resonance between the powertrain and the mount. For this reason, the resonance should be reproduced to reproduce the shock load in a single mount.

Conventionally, a shock fatigue test for a mount in a rough road travel condition is conducted on an actual vehicle, so it is difficult to accurately determine under what shock load conditions fractures occurred, making it difficult to implement an optimal design for the mount. Moreover, when the mount is damaged, the portions surrounding and supported by the mount may also be damaged, which leads to problems such as the cost to fix the damaged areas and therefore monetary loss.

Therefore, it is important to perform verification using a testing device capable of reproducing the test conditions implemented in a shock resistance test conducted in a rough road travel condition, which conventionally could only be conducted on an actual vehicle.

To this end, as illustrated in FIG. 1, a shock fatigue testing device for a powertrain mount according to the embodiment includes a main frame 100, a first mount jig 200, a second mount jig 300, a weight portion 400, and a vibration portion 500.

The main frame 100 includes a guide support 120 disposed upright from the corners of a base plate 110 and vertically extending to have a predetermined length. The main frame also includes a mounting plate 130 coupled to the guide support 120 by facing the base plate 110 to reproduce the cross member of a vehicle.

The first mount jig 200 and the second mount jig 300 are mounted at a bottom center surface of the mounting plate 130 to respectively support the upper portion and the lower portion of a mount member 10, which is a target for a shock fatigue test.

The weight portion 400 is a structure configured to reproduce the powertrain of a vehicle, and is configured to apply a load to the mount member 10 by being fixed to the second mount jig 300.

In other words, because the weight portion 400 is hung from the mount member 10 using the second mount jig 300, a load created by the weight thereof may be applied to the mount member 10, reproducing the weight of the powertrain of a vehicle.

The weight portion 400 may include a plurality of unit weights stacked on top of one another or stacked together.

In other words, the weight portion 400 has a structure in which the plurality of unit weights is stacked to reproduce the weight of the powertrain of a vehicle, and the unit weights are provided to be assembled or disassembled. As such, the weight portion 400 may be selectively varied in weight to reproduce the weight of the powertrain.

More specifically, the weight portion 400 may have formed therein four holes into which four guide shafts 112 may be inserted so that left-right movement thereof caused by the resonance during its vertical movement is restrained. With this structure, the weight portion 400 may increase in weight by adding more unit weights in a manner of allowing the guide shafts 112 to pass through the four holes, respectively. Alternatively, the weight portion 400 may decrease in weight by removing some unit weights in the same manner.

Accordingly, the weight portion 400 may effectively reproduce the weight of the powertrain. Moreover, by forming a through hole in a central portion of the unit weights, a shaft 410 passes through the through hole and protrudes from the bottom of the weight portion 400 to be fastened at one end by a nut 412. As a result, the plurality of unit weights are stacked together or collectively to constitute the weight portion 400.

The vibration portion 500 continuously provides vibration to the base plate 110 to vertically vibrate the weight portion 400 using the main frame 100, the first mount jig 200, and the second mount jig 300 as media.

Preferably, the natural frequency of the mount member 10, calculated based on the weight (or mass) of the weight portion 400 and the characteristic value (damping coefficient, spring constant) of the mount member 10, i.e., calculated by the following [Formula], is used. The natural frequency is inputted together with a predetermined amplitude and an excitatory gradient sinusoidal wave, such that the vibration portion 500 may generate a vibration with a predetermined cycle.

$$( f ) = ( 1 / 2 π ) \sqrt{spring constant ( k ) / mass ( m )} \qquad [ Formula ]$$

To this end, the shock fatigue testing device for a powertrain mount according to the embodiment further includes a controller 600, as shown in FIG. 2.

The controller 600 may compare the shock load applied to the mount member 10 with an inputted target load to selectively increase or decrease the amplitude of the vibration portion 500.

In other words, the controller 600 receives in real time the load applied to the mount member 10 from a load cell 210 that is attached to the first mount jig 200. The controller 600 compares the load with the target load previously inputted, and repetitively vibrates the vibration portion 500 by increasing or decreasing the amplitude of the vibration portion 500 until the load coincides with the target load. Additionally, the controller 600 reproduces the resonance with a corresponding amplitude, allowing the shock fatigue test to be continuously conducted.

Preferably, the shock fatigue testing device for a powertrain mount according to the embodiment includes a displacement measurer 220 mounted to the guide support 120 and configured to evaluate a displacement of the weight portion 400 in the vertical movement. The controller 600 calculates and outputs the velocity and acceleration of the weight portion 400 using the displacement measurement for the weight portion 400 received from the displacement measurer 220. More specifically, using the displacement measurement for the weight portion 400 detected by a non-contact laser displacement meter 222 included in the displacement measurer 220, the controller 600 analyzes the shock load applied from the load cell 210 to the mount member 10 and outputs the velocity and acceleration of the weight portion 400.

In other words, displacement in mechanical vibrations is generally derivative of displacement is velocity, and the second derivative of displacement is acceleration. When the mount member 10 vibrates with the amplitude inputted to the controller 600, the controller 600 evaluates and analyzes the shock load on the mount member 10 transmitted from the load cell 210, the displacement measurement transmitted from the displacement measurer 220, and the velocity and acceleration obtained by differentiating the displacement measurement to evaluate the shock fatigue resistance of the mount member 10 vibrating with the inputted amplitude.

As such, the controller 600 makes a comparison between the load applied to the mount member 10 and the inputted target load to selectively increase or decrease the amplitude of the vibration portion 500 until the two loads coincide with each other. When the two loads coincide with each other, which means that the amplitude of the vibration portion 500 corresponds to the amplitude generated when a maximum shock load is applied to an actual vehicle, the vibration portion 500 is controlled to continuously vibrate with the amplitude to conduct the shock fatigue test. This is achieved by reproducing a continuous shock load of 10 to 15 Hz, which is the same as the continuous shock load applied to an actual vehicle, in the mount member 10.

Therefore, in the embodiment, the shock resistance test to evaluate the shock resistance performance in a rough road travel condition, which could only be conducted on an actual vehicle, may be conducted by reproducing the test conditions in the shock fatigue testing device. As a result, this process results in reducing work time for development, implementing optimal design for the mount member 10, and effectively verifying the same.

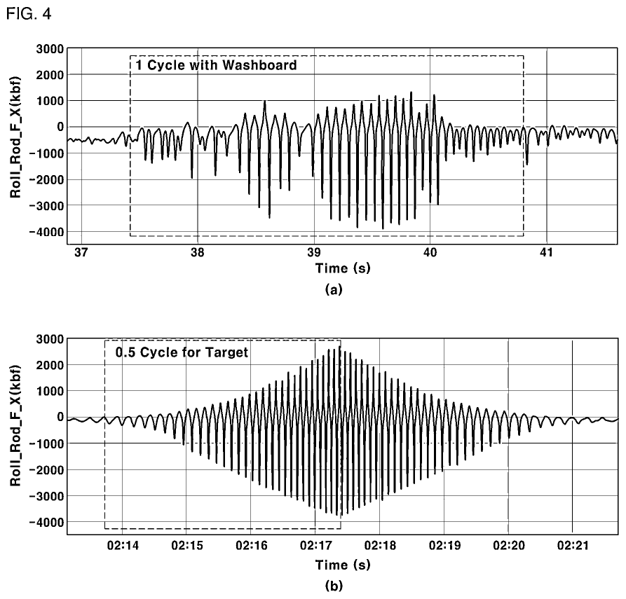

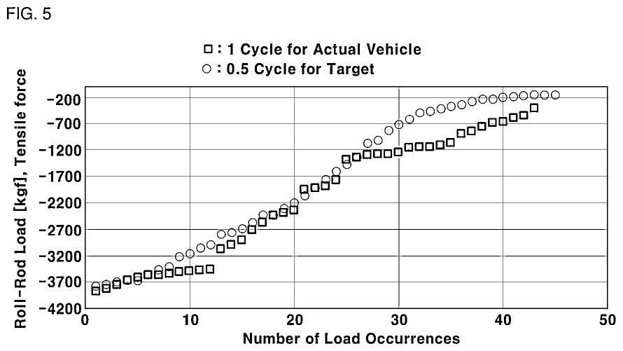

Hereinafter, FIG. 3 is a flowchart of a method for shock fatigue testing for a powertrain mount according to an embodiment of the present disclosure. FIG. 4 shows a comparison between a shock load on an actual vehicle and the shock load reproduced in a target in a method for shock fatigue testing for a powertrain mount according to an embodiment of the present disclosure. FIG. 5 shows a comparison between the load values and the number of load occurrences in 1 cycle for an actual vehicle and the same in 0.5 cycle for a target in a method for shock fatigue testing for a powertrain mount according to an embodiment of the present disclosure.

As shown in FIG. 3, a method for shock fatigue testing for a powertrain mount according to an embodiment of the present disclosure is sequentially described as follows.

First, a target load on the mount member 10 is inputted to the controller 600, at step S100.

More preferably, the target load may be set to a predetermined maximum shock load on an actual vehicle.

Thereafter, the weight (or mass) of the weight portion 400, the characteristic value (damping coefficient, spring constant) of the mount member 10, an arbitrary excitatory gradient, and an initial amplitude to generate a vibration are inputted to the controller 600, at step S200.

The natural frequency of the mount member 10 is calculated using [Formula] below based on the weight (or mass) of the weight portion 400 and the characteristic value of the mount member 10, at step S300.

$$( f ) = ( 1 / 2 π ) \sqrt{spring constant ( k ) / mass ( m )} \qquad [ Formula ]$$

At step S400, the controller 600 controls the vibration portion 500 to generate a vibration having a predetermined cycle with the amplitude and the excitatory gradient sinusoidal wave, which are inputted at step S200, together with the calculated natural frequency of the mount member 10.

Thereafter, the controller 600 calculates and outputs the velocity and acceleration of the weight portion 400 using the displacement measurement for the weight portion 400 received from the displacement measurer 220. The controller 600 analyzes the shock load applied from the load cell 210 to the mount member 10 and outputs the velocity and acceleration of the weight portion 400, at step S500. In other words, displacement in mechanical vibrations is generally derivative of displacement is velocity, and the second derivative of displacement is acceleration. When the mount member 10 vibrates with the amplitude inputted to the controller 600, the controller 600 evaluates and analyzes the shock load on the mount member 10 transmitted from the load cell 210, the displacement measurement transmitted from the displacement measurer 220, and the velocity and acceleration obtained by differentiating the displacement measurement to evaluate the shock fatigue resistance of the mount member 10 vibrating with the inputted amplitude.

At step S600, the controller 600 makes a comparison between the shock load applied to the mount member 10 and the target load inputted at step S100. The controller 600 selectively increases or decreases the amplitude of the vibration portion 500 depending on whether the two loads coincide with each other.

When it is determined that the load applied to the mount member 10 does not coincide with the inputted target load, the controller 600 increases or decreases the amplitude of the vibration portion 500 in increments of, e.g., 1 mm, at step S610.

More preferably, the amplitude of the vibration portion 500 may be increased or decreased repeatedly, e.g., three or more times, to generate a vibration with the amplitude resulting therefrom to re-conduct the analysis.

When it is determined that the load applied to the mount member 10 coincides with the inputted target load, which means that the amplitude obtained from the above process corresponds to the amplitude generated when a maximum shock load is applied to an actual vehicle, the vibration portion 500 is controlled to vibrate with the amplitude to conduct the shock fatigue test at step S620. As a result, the vibration portion 500 reproduces the continuous shock load applied to an actual vehicle and provides the same to the mount member 10.

Regarding the above, the graph of FIG. 4 (a) shows that the waveform and the shock load, generated in the actual vehicle traveling harshly on a rough road including a continuously uneven area, have a resonance frequency of 12 to 15 Hz and a maximum load of 3,681 kgf. In comparison, the graph of FIG. 4 (b) shows that the waveform and the shock load generated in the embodiment have a resonance frequency of 10 to 12 Hz and a maximum load of 3,202 kgf, which are at the same level as those generated in the actual vehicle.

In other words, FIG. 4 (a) is a graph of actual vehicle test data showing, over time, the load applied to the mount during 1 cycle of an actual vehicle with a washboard traveling in a full-load acceleration on a road surface. FIG. 4 (b) is a graph showing the result of simulating the load applied to an actual vehicle in a target testing device where the load applied to an actual vehicle is implemented with an appropriate load application condition.

A 3-second section from about 37.5 seconds to 40.5 seconds in the actual vehicle data (dashed box in FIG. 4 (a)) corresponds to one test cycle. A 3-second section from 2 minutes 14.5 seconds to 2 minutes 17.5 seconds in the target testing device data (dashed box in FIG. 4 (b)), which corresponds to the 3-second section in the actual vehicle data, corresponds to a 0.5 test cycle. The 0.5 test cycle is based on one test cycle for the target testing device (i.e., from starting excitation, reaching target load and then reducing to no load, a section of 6 seconds, from 2 minutes 14.5 seconds to 2 minutes 20.5 seconds).

FIG. 5 shows a comparison between the load values and the number of load occurrences in 1 cycle for an actual vehicle and the same in 0.5 cycle for a target. The comparison is done to check the mutual consistency between an actual vehicle load and the actual vehicle load simulated in the target testing device.

The number of load occurrences in the corresponding section counts 45 for the actual vehicle and 43 for the target, which shows that the number of occurrences of a load of approximately 2,000 kgf or above, effective as a shock load, is almost similar in the actual vehicle and the target. As a result, the shock load in 1 cycle for the actual vehicle is almost exactly reproduced in a 0.5 cycle for the target. In this sense, for a component with a target load of 10 cycles in an actual vehicle, the equivalent load may be obtained in the target in 5 cycles.

Therefore, in the embodiment, the shock resistance test to evaluate the shock resistance performance in a rough road travel condition, which could only be conducted on an actual vehicle, may be conducted by reproducing the test conditions in the shock fatigue testing device, thereby reducing work time for development, implementing optimal design for the mount member 10, and effectively verifying the same.

As is apparent from the above description, the present disclosure provides the following effects.

According to the present disclosure, a plurality of conditions for shock load occurrences is inputted to a shock fatigue testing device together with the mass and characteristic value of a weight portion and a mount mounted to the shock fatigue testing device to excite the shock fatigue testing device. The shock load on the mount is compared with a set shock load on a target to change the amplitude of the shock fatigue testing device. When the shock load on the mount coincides with the shock load on the target, a shock fatigue test is conducted in a condition in which the mount vibrates with a corresponding amplitude. As a result, the shock resistance test evaluates the shock resistance performance in a rough road travel condition, which could only be conducted on an actual vehicle, to be conducted in the shock fatigue testing device by reproducing actual vehicle test conditions in the testing device.

Moreover, according to the present disclosure, the continuous shock load of 10 to 15 Hz, which is implemented in the actual vehicle test, may be reproduced in the shock fatigue testing device. As a result, the testing device conducts the shock fatigue test, which was conventionally conducted in a travel condition under a heavy shock load in a continuously uneven area.

In the above, embodiments of the present disclosure have been described with reference to the accompanying drawings. However, those having ordinary skill in the art to which the present disclosure pertains should understand that various modifications may be made therefrom, and that all or part of the above-described embodiment(s) may be selectively combined. Therefore, the true technical protection scope of the present disclosure should be determined by the technical ideas of the appended claims.

What is claimed is:

1. A shock fatigue testing device for a powertrain mount, the device comprising:
a main frame comprising a guide support vertically extending from a base plate and a mounting plate coupled to the guide support;
a first mount jig mounted to the mounting plate and configured to support an upper portion of a mount member;
a second mount jig mounted to a lower portion of the mount member and configured to support the lower portion of the mount member;
a weight portion fixed to the second mount jig and configured to apply a load to the mount member; and
a vibration portion configured to continuously provide vibration to the base plate to vibrate the weight portion using the main frame, the first mount jig, and the second mount jig as media.

2. The device of claim 1, further comprising a controller configured to make a comparison between the load applied to the mount member and an inputted target load to selectively increase or decrease an amplitude of the vibration portion.

3. The device of claim 2, wherein the target load is inputted by being set to a maximum shock load on an actual vehicle.

4. The device of claim 2, wherein the controller is further configured to calculate a natural frequency of the mount member using a weight measurement for the weight portion and a characteristic value of the mount member to control the vibration portion to vibrate at a frequency identical to the calculated natural frequency of the mount member and with an inputted amplitude.

5. The device of claim 2, wherein the controller is further configured to receive the load applied to the mount member from a load cell attached to the first mount jig in real time and to compare the same with the inputted target load.

6. The device of claim 2, further comprising a displacement measurer mounted to the guide support and configured to evaluate a displacement of the weight portion in a vertical movement.

7. The device of claim 6, wherein the controller is further configured to calculate and output a velocity and an acceleration of the weight portion using a displacement measurement for the weight portion received from the displacement measurer.

8. The device of claim 1, wherein the weight portion has a structure in which a plurality of unit weights is stacked, and is selectively varied in weight by assembling or disassembling the unit weights.

9. The device of claim 1, wherein the weight portion is coupled to a plurality of guide shafts disposed upright from the base plate by allowing the plurality of guide shafts to pass through four corners of the weight portion, respectively, and moves up and down along the guide shafts by vibration.

10. A method for shock fatigue testing for a powertrain mount, the method comprising:
a first step of inputting a target load of a mount member to a controller;
a second step of calculating, by the controller, a natural frequency of the mount member using a weight measurement for a weight portion and a characteristic value of the mount member to control a vibration portion to vibrate at a frequency identical to the calculated natural frequency of the mount member and with an inputted amplitude;
a third step of receiving, by the controller, the load applied to the mount member in real time to compare the same with the target load; and
a fourth step of, when the load applied to the mount member coincides with the target load, controlling the vibration portion to vibrate with a corresponding amplitude.

11. The method of claim 10, wherein the fourth step comprises, when the load applied to the mount member does not coincide with the target load, selectively increasing or decreasing, by the controller, the amplitude of the vibration portion.

12. The method of claim 10, wherein the third step comprises measuring a displacement of the weight portion in a vertical movement to calculate and output, by the controller, a velocity and an acceleration of the weight portion using the displacement measurement.
